(19) United States
(12) Patent Application Publication
(10) Pub. No.: US 2003/0199258 A1
(43) Pub. Date: Oct. 23, 2003

(54) Received-signal gain control apparatus and radio communication apparatus

(75) Inventors: Shigeru Matsuki, Kokubunji-shi (JP); Hideki Aisaka, Hino-shi (JP)

Correspondence Address: BANNER & WITCOFF, 1001 G STREET N W, SUITE 1100, WASHINGTON, DC, 20001, US

(73) Assignee: Kabushiki Kaisha Toshiba, Minato-ku (JP)

(21) Appl. No.: 10/382,933

(22) Filed: Mar. 7, 2003

(30) Foreign Application Priority Data
Apr. 17, 2002 (JP) 2002-115214

(51) Int. Cl. H04B 17/02

(52) U.S. Cl. 455/136; 455/138

(57) ABSTRACT

A gain control part controls a gain varying part such that the gain of a received signal corresponds to the input level of the received signal in a first control mode and controls the gain varying part so as to fix the gain of the received signal in a second control mode. A setting part sets the gain control part in the first control mode in a communication state and sets the gain control part in the second control mode in a standby mode.

### CROSS-REFERENCE TO RELATED APPLICATIONS

This application is based upon and claims the benefit of priority from the prior Japanese Patent Application No. 2002-115214, filed Apr. 17, 2002, the entire contents of which are incorporated herein by reference.

### BACKGROUND OF THE INVENTION

1. Field of the Invention

The present invention relates to a received-signal gain control apparatus that controls the gain of a received signal in accordance with the input level of the received signal and a radio communication apparatus.

2. Description of the Related Art

QPCH control is adopted in the 1× standard that is standardized by the 3GPP2 (3rd Generation Partnership Project 2) of the ITU (International Telecommunication Union).

The QPCH control is to determine whether an operation of receiving a PC (Paging Channel) is performed based on the states of two Forward-QPCH of PI1 and PI2 that are transmitted immediately before the PC is done. When one of PI1 and PI2 is “0,” no PC is received. Only when both PI1 and PI2 are “1,” a PC is received in the timing of the next PC.

Adopting the above QPCH control allows time for performing the receiving operation to be shortened further and allows current consumption to decrease.

However, each Forward-QPCH is formed of one bit. Under the circumstances where an error detection rate increases, therefore, the proportion of error detection of Forward-QPCH will increase.

If it is determined by error detection that PI1 and PI2 are both “1,” the PC will be received though it need not be done originally. This causes current to be consumed wastefully.

It is thus desirable to detect Forward-QPCH with high precision.

### BRIEF SUMMARY OF THE INVENTION

The present invention has been developed in consideration of the above situation and its object is to allow a given signal to be detected with high precision in a standby state.

According to a first aspect of the present invention, there is provided a received-signal gain control apparatus which is applied to a radio communication apparatus, the received-signal gain control apparatus comprising a signal detecting part configured to detect a specific signals in a standby state, a gain varying part configured to vary a gain of the received signal, a gain control part configured to control the gain varying part such that the gain of the received signal has a value corresponding to an input level of the received signal in a first control mode and control the gain varying part so as to fix the gain of the received signal in a second control mode, and a setting part configured to set the gain control part in the first control mode in a communication state and set the gain control part in the second control mode in the standby state.

According to a second aspect of the present invention, there is provided a received-signal gain control apparatus which is applied to a radio communication apparatus, the received-signal gain control apparatus comprising a signal detecting part configured to detect a specific signal in a standby state in a first communication mode and detect no given signal from the received signals in the standby state in a second communication mode, a gain varying part configured to vary a gain of the received signal, a gain control part configured to control the gain varying part such that the gain of the received signal has a value corresponding to an input level of the received signal in a first control mode and control the gain varying part so as to fix the gain of the received signal in a second control mode, and a setting part configured to set the gain control part in the first control mode in the first communication mode and in a communication state, set the gain control part in the second control mode in the first communication mode and in the standby state, and set the gain control part in the second control mode in the second communication mode.

According to a third aspect of the present invention, there is provided a radio communication apparatus comprising a signal detecting part configured to detect a specific signal in a standby state, a gain varying part configured to vary a gain of the received signal, a gain control part configured to control the gain varying part such that the gain of the received signal has a value corresponding to an input level of the received signal in a first control mode and control the gain varying part so as to fix the gain of the received signal in a second control mode, and a setting part configured to set the gain control part in the first control mode in a communication state and set the gain control part in the second control mode in the standby state.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a mobile communication apparatus according to an embodiment of the present invention;

FIG. 2 is a flowchart showing a received-signal gain setting process;

FIG. 3 is a graph showing a relationship between the input level of a received signal and the gain of an LNA when the communication mode is a 1× mode and the operating state is a communication state or when the communication mode is an IS-95 mode;

FIG. 4 is a graph showing a relationship between the input level of the received signal and the sensitivity characteristics;

FIG. 5 is a graph showing a relationship between the input level of the received signal and the error detection rate in a standby state of a radio communication apparatus adopting QPCH control;

FIG. 6 is a graph showing a relationship between the input level of the received signal and the gain of the LNA when the communication mode is a 1× mode and the operating state is a standby state;

FIG. 7 is a graph showing a relationship between the level of a received signal and the error detection rate in the QPCH control;

FIG. 8 is a graph showing a modification to a method of changing the gain of the LNA;

FIG. 9 is a graph showing another modification to a method of changing the gain of the LNA; and

FIG. 10 is a graph showing still another modification to a method of changing the gain of the LNA.

### DETAILED DESCRIPTION OF THE INVENTION

An embodiment of the present invention will now be described with reference to the accompanying drawings.

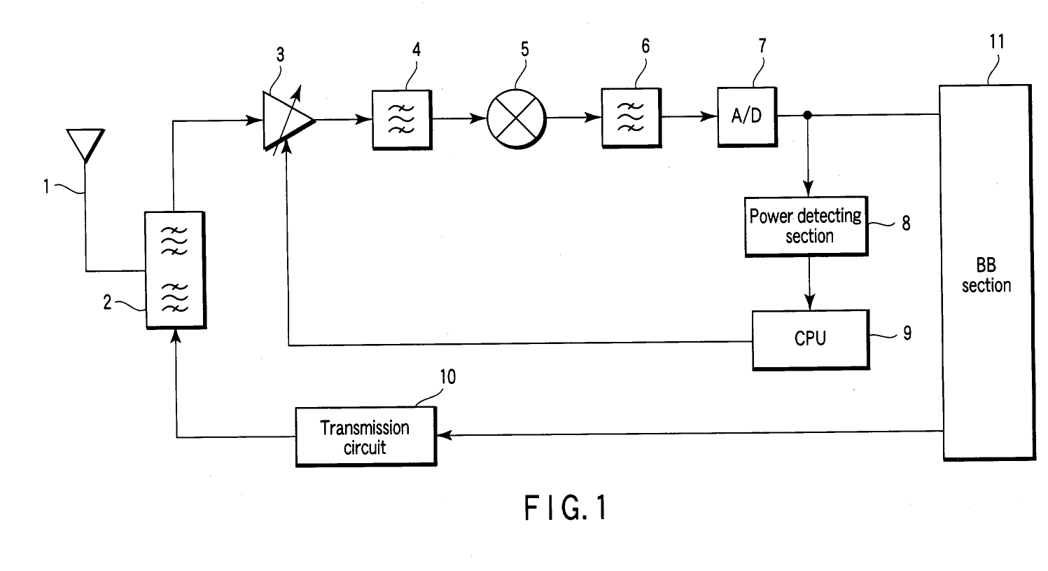

FIG. 1 is a block diagram of a mobile communication apparatus according to the embodiment of the present invention.

Referring to FIG. 1, the mobile communication apparatus includes an antenna 1, a duplexer 2, an LNA (Low-Noise Amplifier) 3, a band-pass filter 4, a mixer 5, a band-pass filter 6, an A/D converter 7, a power detecting section 8, a CPU 9, a transmission circuit 10 and a baseband (BB) section 11.

The antenna 1 receives a radio wave that is moved in the air and generates an electrical signal or a received signal. The duplexer 2 eliminates an unnecessary out-of-band signal from the received signal. Then, the LNA 3 amplifies the received signal. The band-pass filter 4 eliminates an unnecessary component from the received signal. The LNA 3 can control the gain of the received signal by varying the gain of the LNA 3.

After that, the mixer 5 mixes the received signal with a local signal (not shown) to down-convert it into a received signal having an intermediate frequency. The band-pass filter 6 eliminates an unnecessary component from the down-converted received signal. The A/D converter 7 digitizes the resultant received signal and supplies it to the power detecting section 8 and baseband section 11.

The power detecting section 8 detects an input level of the received signal supplied from the A/D converter 7 and notifies the CPU 9 of the detected input level.

The CPU 9 controls the gain of the LNA 3 in accordance with the input level notified by the power detecting section 8 and the state of the mobile communication apparatus.

The transmission circuit 10 converts the transmission signal output from the baseband section 11 into a transmission signal having a radio frequency. The duplexer 2 eliminates an unnecessary out-of-band signal and supplies it to the antenna 1. The antenna 1 radiates the signal.

The baseband section 11 processes the received signal and generates a transmission signal. The baseband section 11 also performs a standby process. The baseband section 11 is adapted to both the 1× standard and IS-95 standard.

An operation of the mobile communication apparatus of the above configuration will now be described.

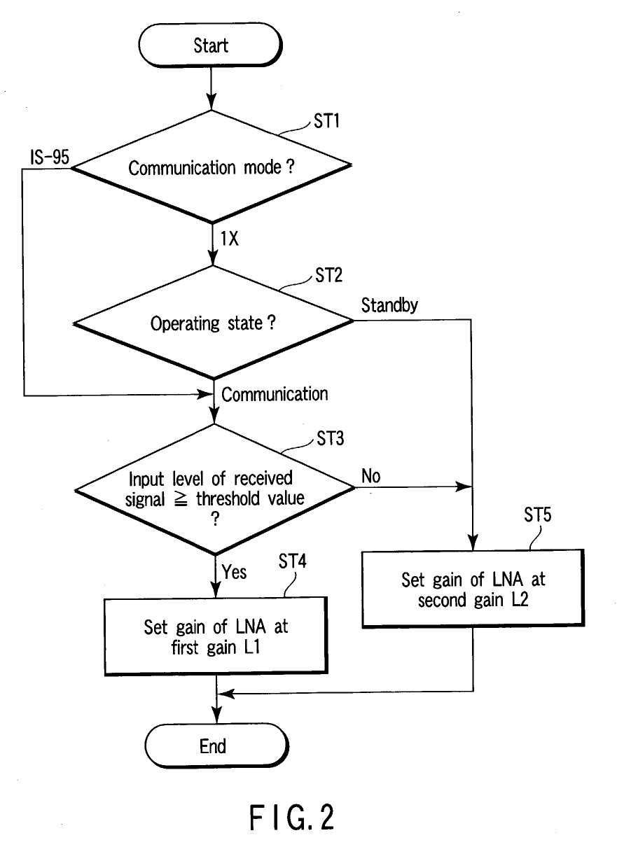

The CPU 9 performs a received-signal gain setting process, as shown in FIG. 2, in given timing or at regular time intervals.

First, the CPU 9 confirms which of 1× and IS-95 modes is set as a communication mode in step ST1. When the CPU 9 confirms that the communication mode is the 1× mode, it confirms whether the operating state is a communication state or a standby state.

When the CPU 9 confirms that the operating state is the communication state or it confirms in step ST1 that the communication mode is the IS-95 mode, the process advances to step ST3. The CPU 9 confirms in step ST3 whether the input level notified by the power detecting section 8 becomes not lower than a threshold value.

If the CPU 9 confirms that the input level becomes not lower than the threshold value, it sets the gain of the LNA 3 at a first gain L1 in step ST4. The first gain L1 is set lower to prevent the sensitivity from decreasing due to an interference wave that results distorting the received signal. When the gain of the LNA 3 is completely set at the first gain L1, the CPU 9 ends the received-signal gain setting process.

In contrast, when the CPU 9 confirms in step ST3 that the input level is lower than the threshold value or it confirms in step ST2 that the operating state is a standby state, the process advances to step ST5. In step ST5, the CPU 9 sets the gain of the LNA 3 at a second gain L2. The second gain L2 is set higher in such a manner that the sensitivity can satisfy the standards even under circumstances where the input level lowers to some extent. The second gain L2 is therefore greater than the first gain L1. When the gain of the LNA 3 is completely set at the first gain L1, the CPU 9 ends the received-signal gain setting process.

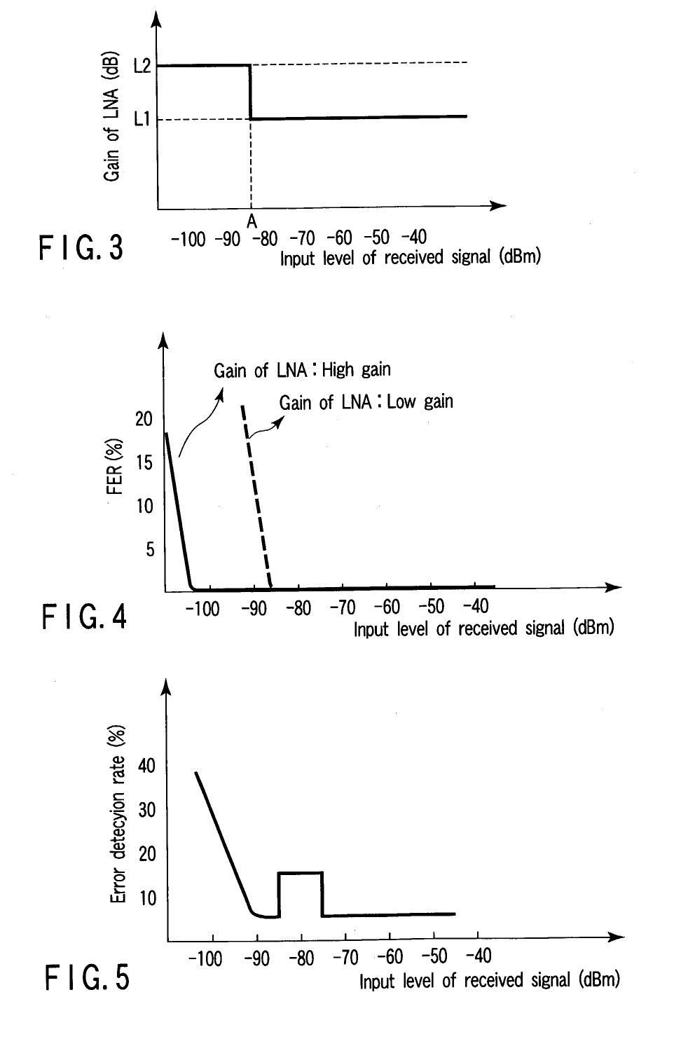

As described above, when the communication mode is the 1× mode and the operating state is the communication state or when the communication mode is the IS-95 mode, the gain of the LNA 3 is changed according to whether the input level is not lower than the threshold value A as shown in FIG. 3. It is thus possible to secure a considerably higher sensitivity by the high-gain amplification in the LNA 3 when the input level is somewhat low. Since the gain of the LNA 3 decreases when the input level is high, the received signal is not distorted by the amplification in the LNA 3, thus preventing the sensitivity from deteriorating due to an interference wave. FIG. 4 shows an example of a relationship between the input level of the received signal and sensitivity characteristics.

According to the above embodiment, when the communication mode is the IS-95 mode, the gain of the LNA 3 is changed irrespective of the operating state. It is thus possible to reduce the current consumption of the LNA 3 when the input level of the received signal is high.

However, the change in the gain of the LNA 3 generates noise on the output of the LNA 3. Due to the influence of the noise, a relationship as shown in FIG. 5 is established between the input level of the received signal and the error detection rate in the standby state. In other words, the error detection rate increases when the level of the received signal is approximate to a value for the change in the gain of the LNA 3. This increase in the error detection rate is likely to detect the Forward-QPCH erroneously.

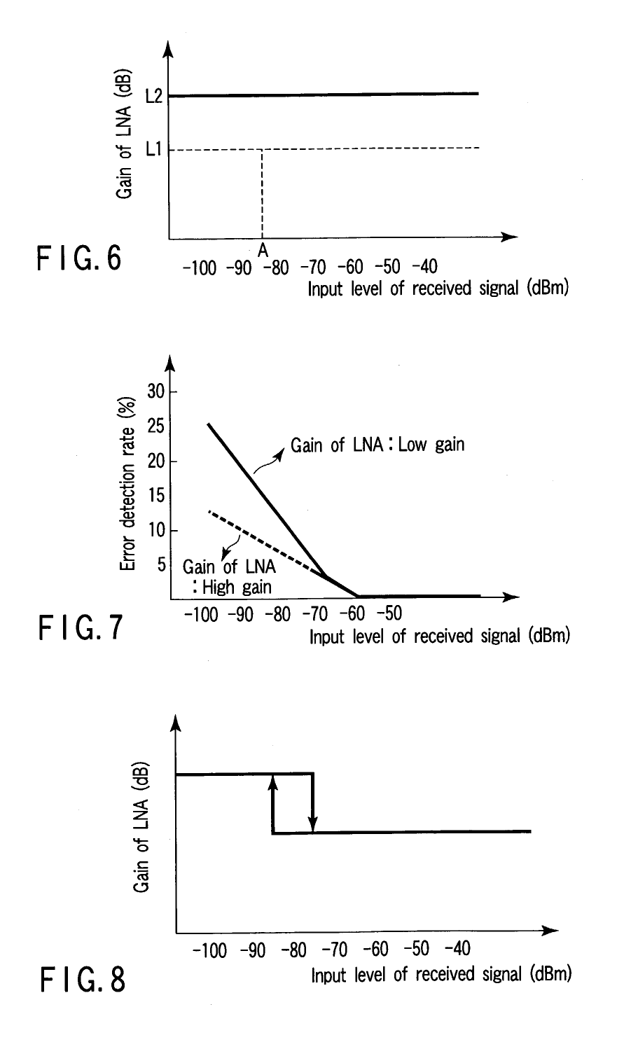

However, when the communication mode is the 1× mode and the operating state is the standby state, the gain of the LNA 3 is fixed to the second gain L2 irrespective of the level of the received signal as shown in FIG. 6. In this case, the gain of the LNA 3 is not changed though the baseband section 11 performs the QPCH control; therefore, noise that is erroneously detected as a Forward-QPCH does not occur on the received signal. Consequently, the baseband section 11 can perform the QPCH control appropriately to minimize the operation of receiving a PC and reduce the current consumption.

A relationship as shown in FIG. 7 is established between the input level of the received signal and the error detection rate in the QPCH control in both cases where the gain of the LNA 3 is low (=first gain L1) and it is high (=second gain L2). As is seen from the relationship, when the input level is −70 dBm or higher, there is no difference in error detection rate between the high and low gains. When it is lower than −70 dBm, the proportion of error detection in the high gain is lower than that in the low gain. Consequently, when the QPCH control is performed, the LNA 3 is fixed to a high gain or a second gain L2 to make the number of detected errors smaller.

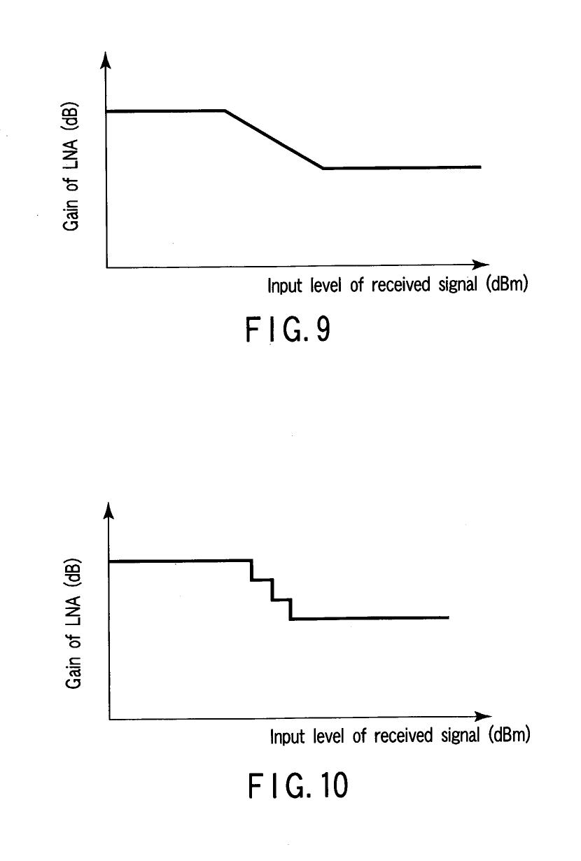

The present invention is not limited to the above embodiment. For example, the gain of the LNA 3 can be changed so as to have hysteresis characteristics as shown in FIG. 8. Furthermore, the gain of the LNA 3 can continuously be varied with the variations in the input level of the received signal as shown in FIG. 9 or it can be varied in a number of stages as shown in FIG. 10. In the case as shown in FIG. 10, too, the gain of the LNA 3 can be changed so as to have the hysteresis characteristics.

The gain of the received signal can be controlled by varying the gain of an amplifier other than the LNA 3 or by varying the gain of an attenuator. It also can be controlled by varying the gain of each of a plurality of devices.

Even when the communication mode is the IS-95 mode, the gain of the LNA 3 can be fixed if the operating state is a standby state. In other words, a method of controlling the gain of the LNA 3 can be changed according to the communication state or the standby state, irrespective of the communication mode.

The signal detected from the received signal is not limited to the Forward-QPCH but can be an arbitrary signal. In other words, the communication mode for detecting a given signal is not limited to a mode complying with the 1× standard.

The present invention can be applied to a terminal that differs in type from a mobile communication apparatus.

The present invention is not limited to a radio communication apparatus but can be mounted on a radio communication apparatus to serve as a unit configured to control the gain of a received signal in the radio communication apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A received-signal gain control apparatus which is applied to a radio communication apparatus, the received-signal gain control apparatus comprising:
a signal detecting part configured to detect a specific signal in a standby state;
a gain varying part configured to vary a gain of the received signal;
a gain control part configured to control the gain varying part such that the gain of the received signal has a value corresponding to an input level of the received signal in a first control mode and control the gain varying part so as to fix the gain of the received signal in a second control mode; and
a setting part configured to set the gain control part in the first control mode in a communication state and set the gain control part in the second control mode in the standby state.

2. The received-signal gain control apparatus according to claim 1, wherein the gain control part controls the gain varying part such that the gain of the received signal is determined as one of a first received-signal gain and a second received-signal gain, in accordance with the input level of the received signal in the first control mode.

3. The received-signal gain control apparatus according to claim 2, wherein the gain control part causes the gain varying part to vary the gain of the received signal so as to have hysteresis characteristics.

4. The received-signal gain control apparatus according to claim 1, wherein the gain control part controls the gain varying part such that the gain of the received signal is determined as one of gains of received signal in a number of stages, in accordance with the input level of the received signal in the first control mode.

5. The received-signal gain control apparatus according to claim 4, wherein the gain control part causes the gain varying part to vary the gain of the received signal so as to have hysteresis characteristics.

6. The received-signal gain control apparatus according to claim 1, wherein the gain control part controls the gain varying part such that the gain of the received signal is continuously varied in accordance with the input level of the received signal in the first control mode.

7. A received-signal gain control apparatus which is applied to a radio communication apparatus, the received-signal gain control apparatus comprising:
a signal detecting part configured to detect a specific signal in a standby state in a first communication mode and detect no given part of a received signals in the standby state in a second communication mode;
a gain varying part configured to vary the gain of the received signal;
a gain control part configured to control the gain varying part such that the gain of the received signal has a value corresponding to an input level of the received signal in a first control mode and control the gain varying part so as to fix the gain of the received signal in a second control mode; and
a setting part configured to set the gain control part in the first control mode in the first communication mode and in a communication state, set the gain control part in the second control mode in the first communication mode and in the standby state, and set the gain control part in the second control mode in the second communication mode.

8. The received-signal gain control apparatus according to claim 7, wherein the gain control part controls the gain varying part such that the gain of the received signal is determined as one of a first received-signal gain and a second received-signal gain, in accordance with the input level of the received signal in the first control mode.

9. The received-signal gain control apparatus according to claim 8, wherein the gain control part causes the gain varying part to vary the gain of the received signal so as to have hysteresis characteristics.

10. The received-signal gain control apparatus according to claim 7, wherein the gain control part controls the gain varying part such that the gain of the received signal is determined as one of gains of received signal in a number of stages, in accordance with the input level of the received signal in the first control mode.

11. The received-signal gain control apparatus according to claim 10, wherein the gain control part causes the gain varying part to vary the gain of the received signal so as to have hysteresis characteristics.

12. The received-signal gain control apparatus according to claim 7, wherein the gain control part controls the gain varying part such that the gain of the received signal is continuously varied in accordance with the input level of the received signal in the first control mode.

13. A radio communication apparatus comprising:
a signal detecting part configured to detect a specific signal in a standby state;
a gain varying part configured to vary a gain of the received signal;
a gain control part configured to control the gain varying part such that the gain of the received signal has a value corresponding to an input level of the received signal in a first control mode and control the gain varying part so as to fix the gain of the received signal in a second control mode; and
a setting part configured to set the gain control part in the first control mode in a communication state and set the gain control part in the second control mode in the standby state.
